(19) United States
(12) Patent Application Publication
(10) Pub. No.: US 2019/0137381 A1
(43) Pub. Date: May 9, 2019

(54) TRIPLE LASER SHEET VELOCIMETRY WITH ONE CAMERA

(71) Applicant: Siemens Energy, Inc., Orlando, FL (US)

(72) Inventor: Joshua S. McConkey, Orlando, FL (US)

(21) Appl. No.: 15/803,965

(22) Filed: Nov. 6, 2017

(51) Int. Cl. G01N 15/14; G01P 5/26

(52) U.S. Cl. CPC G01N 15/1429; G01N 2015/1075; G01N 15/1434; G01P 5/26

(57) ABSTRACT

A method and a system to characterize the velocity of a fluid flow through a flow channel using particle image velocimetry with one camera is provided. The method includes introducing a fluid flow into the fluid channel. The fluid includes fluid particles and tracer particles. At least two planar cross sections of the fluid flow are illuminated by a light source of a different color and spaced apart by a fixed distance. Successive images are captured with a single image receiver such as a camera such that each illuminated planar cross section is captured separately with the image receiver. From the captured images, a velocity of the fluid flow through the channel is determined by a processor.

### BACKGROUND

### 1. Field

The present disclosure relates generally to methods to assess characteristics of fluid flow, and more particularly, to a method to characterize the velocity of a fluid flow through a flow channel using particle image velocimetry with a single image receiver.

### 2. Description of the Related Art

Particle Image Velocimetry (PIV) is an optical method of flow visualization used to assess the characteristics of fluid flow. Tracer particles, for example, small droplets of oil or water, are introduced into the flow stream under study. A laser sheet is then shone into the flow field. As the tracer particles subtend the laser sheet, they are illuminated and appear as flashes, but only while in the thin laser sheet. Digital cameras may be used to capture images of a sequence of these flashes of light within the laser sheet(s). A processor is then used to measure and count the particles within the captured images. From these images, the local instantaneous velocity at that part of the flow may be measured based on the movement of the particles through the separate image frames.

Using PIV, one may observe the flashes that occur when a particle passes through a laser sheet. The laser sheet is typically perpendicular to the direction of flow, so that each particle's flash is a one-time occurrence in which a location and a time may be recorded for that particle as it passes through the laser sheet. By comparing data from at least two laser sheets, one can infer the direction and speed of each particle. Statistical analysis may be performed on the tracer particle data in order to estimate the fluid flow. However, having multiple laser sheets may be problematic due to interference between them as viewed from the perspective of the digital camera. For example, the digital camera may not be able to distinguish which laser sheet produced the recorded flash. Furthermore, it may be problematic to determine which image pair constitutes first and second images of the same particle. Complicated laser sheet strobing with coordinated timing control has been used as a solution to this problem, however, the implementation of this solution is very expensive. Alternatively, multiple cameras may be positioned above the laser sheets at high angles with each camera having a field of view of one of the laser sheets. However, the high angles may distort the collection of data and the cameras must be tightly time synchronized.

In a turbomachine, such as a gas turbine engine, air is pressurized in a compressor section then mixed with fuel and burned in a combustion section to generate hot combustion gases. The hot combustion gases are expanded within a turbine section of the engine where energy is extracted from the combustion gases to power the compressor section to produce useful work, such as turning a generator to produce electricity.

Air mass flow is a key measurement of determining the efficiency of a gas turbine. Gas turbine inlet mass flow is difficult to measure accurately because the most accurate measurement methods themselves create an impedance to air flow, which significantly reduces the power produced by the engine. Most techniques to measure the inlet mass flow are either fairly inaccurate or quite expensive. The most difficult part of making this measurement is obtaining a good average or distributed velocity of the flow. Therefore, a highly accurate method for determining flow velocity in a very large duct with a complex geometry such as the inlet to the gas turbine compressor is desired. The method should not significantly affect the fluid flow as this impacts the accuracy of the measurement and the total engine efficiency.

A method and system is thus proposed using particle image velocimetry with a single image receiver to characterize the fluid flow through a gas turbine. The proposed method and system accurately measures the velocity of a fluid flow without significantly affecting the fluid flow. Then, using the obtained velocity, an air mass flow may be easily determined if desired.

### SUMMARY

Briefly described, aspects of the present disclosure relate to a method to characterize the velocity of a fluid flow through a flow channel using particle image velocimetry and a

A method to characterize the velocity of a fluid flow through a flow channel using particle image velocimetry is provided. The method includes the steps of introducing a fluid flow into the fluid channel, illuminating at least two planar cross sections of the fluid flow, recording successive images such that each illuminated planar cross section of the fluid flow is captured separately with a single image receiver having a field of view, and determining the velocity of a fluid flow through the flow channel using the captured images. The fluid flow includes a plurality of fluid particles and a plurality of tracer particles and each planar cross section is illuminated with a light source of a different color.

A system to characterize the velocity of a fluid flow through a flow channel using particle image velocimetry is provided. The system includes a flow channel through which a fluid flows, the fluid comprising a plurality of fluid particles and a plurality of tracer particles. A plurality of light sources, each comprising a different color, supplies optical or infrared radiation in the form of a laser sheet, each laser sheet illuminating a separate cross section of fluid flow in the different color. A single image receiver, having a field of view, captures images of each laser sheet. The captured images are transmitted by the image receiver to a processor communicatively coupled to the image receiver. The processor receives the captured images and is capable of analysing the captured images of the laser sheets.

A method for measuring air mass flow into an inlet of a gas turbine engine is also provided. The method includes introducing an air flow into an inlet of the gas turbine engine and illuminating at least two planar cross sections of the air flow, the planar cross sections spaced apart by a distance. Each planar cross section is illuminated with a light source of a different color. A single image receiver is positioned downstream of the inlet so that the image receiver includes a field of view of each illuminated planar cross section. The image receiver records successive images with the result that each planar cross section of fluid flow is captured separately with the single image receiver. From the captured images, the velocity of each of a plurality of tracer particles are determined utilizing the position of each tracer particle in each illuminated planar cross section and the corresponding timestamp of the captured images. A velocity field of the air flow into the inlet using the captured images may be created as well as a density field of the air flow into the inlet. By combining the velocity and density fields an air mass flow field is created.

### BRIEF DESCRIPTION OF THE DRAWINGS

FIG. 1 illustrates a schematic view of a system for characterizing the velocity of a fluid flow using particle image velocimetry with a single camera.

FIG. 2 illustrates a perspective view of an exemplary particle path, and

FIG. 3 illustrates a schematic diagram of a gas turbine engine.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

Digital color cameras include an electronic sensor that converts the incoming light to electrical signals and typically stores color information in distinct and separate channels by assigning digital values for each unit or pixel of image information. Thus, red, blue, and green components of the image are stored in separate channels of the digital camera. Usually, the digital camera's electronic light sensor is one of two types, a Charge-coupled device (CCD) or a CMOS (Complementary Metal Oxide Semiconductor) image sensor. Digital cameras including CCD sensors produce high quality images with low noise. For the purposes of this disclosure, the image receiver, such as a digital color camera, includes a multichannel imager such as a CCD sensor.

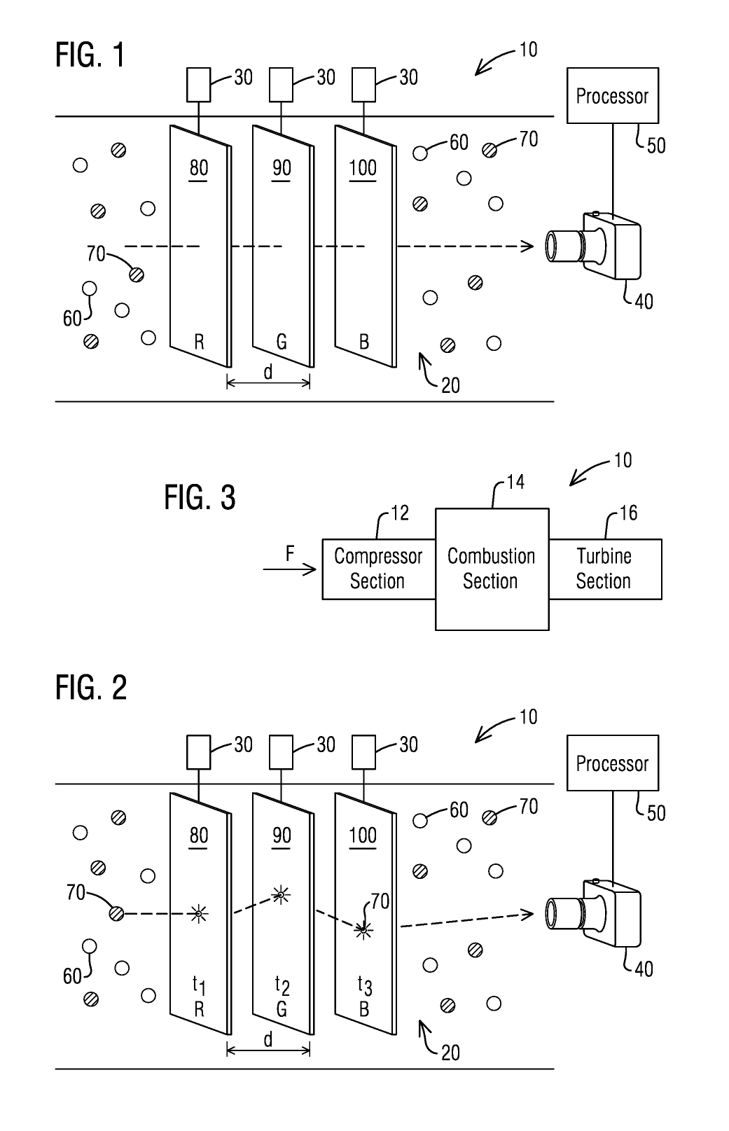

Embodiments will now be described with reference to the figures. FIG. 1 is a schematic view of a system 10 to characterize the velocity of a fluid flow using particle image velocimetry through a flow channel 20. The system 10 includes a flow channel 20 through which a fluid flows in a flow direction (as shown by arrow). The fluid flow may comprise fluid particles 60 whose velocity is to be assessed and a plurality of tracer particles 70 whose velocity is to be measured and used to estimate the velocity of the fluid particles 60. In the shown embodiment, the system 10 further includes a plurality of light sources 30, each comprising a different color. Each light source 30 may supply optical radiation or infrared radiation in the form of a laser sheet 80, 90, 100. Each laser sheet 80, 90, 100 illuminates a separate planar cross section of fluid flow in a different color, denoted on black and white FIG. 1 as red (R), green (G), and blue (B), respectively. In an embodiment, the system 10 includes a single image receiver 40 for capturing images of each laser sheet 80, 90, 100. A processor 50 communicatively coupled to the image receiver 40 and adapted to receive and analyze the captured images of the laser sheets 80, 90, 100 may be included.

The fluid flowing within the flow channel 20 may comprise fluid particles 60 whose velocity is to be assessed and a plurality of tracer particles 70. The tracer particles 70 may be any particle such that when illuminated by the laser sheet 80, they facilitate reflection of the light or infrared radiation which may then be captured by the image receiver 40. The fluid particles 60 may comprise any fluid such as air, combustion gas, and/or liquids.

The different colors used for the illuminated planar cross sections are red, green, and blue, the colors represented in the additive color model in which red, green and blue light are added together in various ways to reproduce a broad array of colors. As such, most digital color cameras include a multichannel imager having a separate channel for each of the colors, red, green, and blue.

The image receiver 40 may be a digital color camera including a multichannel imager, such as a CCD sensor as mentioned above. In an embodiment, the digital color camera 40 may be positioned within the flow channel 20 downstream from each of the laser sheets 80, 90, 100 so that its field of view includes each laser sheet 80, 90, 100. Because the multichannel imager records the colors, red, green, and blue separately, only one field of view is needed in order to capture a view of all of the laser sheets 80, 90, 100. This ability to ‘see’ each of the laser sheets with one field of view enables the digital color camera 40 to be positioned in one location for the recording of all of the successive images. From the digital color camera's position, as shown in FIG. 1, the digital camera 40 includes a field of view of each of the laser sheets 80, 90, 100. A flash occurs, signifying a particle illuminated in a laser sheet 80, 90, 100 as it passes through the laser sheet 80, 90, 100. For example, in the red laser sheet 80, the camera's sensor records the flash only on the red channel 80. The same would be true for the other color laser sheets 90, 100. Thus, the digital color camera 40 does not need to be repositioned in order to capture each of the laser sheets 80, 90, 100.

FIG. 2 illustrates a perspective view of an exemplary tracer particle path. The tracer particle path (denoted by the dashed line with the arrow) shows the tracer particle 70 passing through each illuminated laser sheet 80, 90, 100 at time tₓ and the corresponding flash the tracer particle produces as it passes through each illuminated laser sheet 80, 90, 100. The laser sheets 80, 90, 100 may be spaced apart by a distance (d) in a range of approximately 1 mm to 1 m.

The distance (d) should be chosen so that the camera 40 is able to record the tracer particle 70 in each of the laser sheets 80, 90, 100. In other words, the distance (d) chosen determines a range of fluid flows that may be detected. Other factors which will determine the accuracy of the velocity measurement are the frame rate in frames per second (FPS), describing how often images are taken by the digital camera 40 and the shutter speed describing how long the camera's shutter is open. Taken together the spacing, the frame rate and the shutter speed determines how accurate the velocity measurement is. The frame rate may lie in a range from 10-100,000 FPS based on the fluid flow being measured and the desired resolution/accuracy, with the higher frame rate giving a more accurate flow velocity measurement. Additionally, the accuracy of the velocity measurement may be increased by synchronizing a pulsed laser with the camera shutter speed.

The system 10 may include a processor 50 communicatively coupled to the single image receiver 40. The processor 50 may be configured to carry out various processes and functions described herein by executing software instructions.

Referring again to FIG. 1, a method to characterize the velocity of a fluid flow through a flow channel 20 using particle image velocimetry is presented. The method includes illuminating at least two planar cross sections of fluid flow, the planar cross sections spaced apart by a distance (d), wherein each planar cross section is illuminated with a light source of a different color. The light source 30 used may be a laser source such that each illuminated planar cross section of fluid flow may be referred to as a laser sheet 80, 90, 100. An image receiver 40, such as a digital color camera, may be positioned so that successive images are recorded on the image receiver 40 of each illuminated planar cross section. The tracer particles 70 in the fluid flow would appear as flashes in each recorded image enabling them to be tracked between successive images. Using statistical methods, a processor 50 communicatively coupled to the image receiver 40 may determine the velocity of the fluid flow through the fluid channel utilizing the recorded data of the flashes on the captured images.

In an embodiment, the at least two planar cross sections are illuminated with a different color. The different colors are the colors represented in the additive RGB color model used in most color digital cameras, red, green and blue. In the embodiment shown, three laser sheets 80, 90, 100 are shown, one of each of the colors red, green, and blue. However, in another embodiment, only two laser sheets 80, 90, 100 may be used; each one a different color from the other and selected from the colors, red, green and blue.

In an embodiment, the image receiver 40 is positioned such that the successive images are captured having the same field of view. In the embodiment shown in FIG. 1, the image receiver 40 is positioned within the flow channel 20 downstream, in a flow direction shown by the arrows, from the laser sheets 80, 90, 100. Each laser sheet 80, 90, 100 within the flow channel 20 is positioned perpendicular to the fluid flow with adjacent laser sheets 80, 90, 100 having a distance (d) between them. The distance (d) lies in a range of 1 mm to 1 m. The digital color camera 40 may be positioned directly facing the laser sheets 80, 90, 100 so that its field of view includes each laser sheet 80, 90, 100.

A digital camera 40 may record successive images such that each laser sheet 80, 90, 100 is captured separately in a photograph or by video recording. As each particle passes through a laser sheet, a flash would appear which may be captured by the image receiver 40. The digital camera 40 may record a timestamp for each captured image.

The processor 50 may be configured to carry out various processes and functions described herein by executing software instructions. The processor 50 may be configured to recover an illumination of each of the plurality of tracer particles from a corresponding captured image, the illumination occurring as a result of each tracer particle 70 passing through each laser sheet 80, 90, 100. From the recovered illuminations of each of the plurality of tracer particles, the geometry of the laser sheet, the position of the digital camera, and the recorded timestamp of the image, the processor 50 can determine a position of the tracer particle 70 within the laser sheet 80, 90, 100. Thus, then using the position and timing data for each tracer particle 70 from at least two laser sheets 80, 90, 100, a velocity of that particle may be determined. Statistical analysis may be employed on the velocity data of the tracer particle(s) 70 in order to estimate the velocity of the fluid particles 70 in the flow channel 20.

With the estimated velocity data of each of the plurality of tracer particles 70 measured in the fluid flow within the laser sheet 80, 90, 100, the processor 50 may create a flow field. A velocity flow field may be used for example, to calculate mass flow if the density field is known. It also allows for complex pressure fields and even temperature fields to be calculated if other parameters are known and may be used to assess the performance of complex shapes in flow environments and to understand mixing of the flow. Furthermore, at least three planar cross sections of the fluid flow may be illuminated with different colors. Using estimated velocity flow data from at least three planar cross sections, a more accurate estimate of the fluid flow velocity may be obtained. For example, a three-dimensional representation of the velocity field of the flow may be created.

An embodiment of the method to characterize the velocity of a fluid flow through a flow channel 20 will now be described, however, one skilled in the art would understand that the method may be used to characterize the velocity of any fluid flow through a flow channel 20. A method for measuring air mass flow into an inlet of a gas turbine engine is thus presented. Many of the method steps are similar to those of the previously described method and will not be described in more detail.

Referring now to FIG. 3, a gas turbine engine 10 is schematically shown. The engine 10 includes a conventional compressor, combustion, and turbine sections 12, 14, 16 which will not be discussed in detail herein. The compressor section 12 includes an inlet 20 of the compressor section 12 (hereinafter compressor inlet 20).

In the embodiment, an air flow (F) is introduced into an inlet of a gas turbine engine. A light source 30, such as a laser beam, illuminates at least two planar cross sections of fluid flow, the planar cross sections spaced apart by a distance d.

Each planar cross section is illuminated with a light source 30 of a different color. An image receiver 40, such as a digital color camera, may be positioned downstream of the inlet, the image receiver 40 having a field of view of each illuminated planar cross section. The digital color camera 40 may record successive images such that each illuminated planar cross section of the fluid flow is captured separately with a single image receiver 40.

Utilizing the PIV method described above, the velocity of a plurality of tracer particles 70 may be determined. The velocity of each of the tracer particles 70 is determined based on the position of the particle within each illuminated planar cross section and the timestamp of each captured image. From the calculated velocities of the individual tracer particles 70, a velocity field of the air flow (F) may be created. Additionally, a density field of the tracer particles 70 may easily be determined using the environmental conditions such as pressure, temperature, and humidity conditions in the gas turbine inlet. Lastly, an air mass flow field may be created by combining the created velocity field and the density fields. The velocity, density and air mass flow fields may be one dimensional, two dimensional, or three dimensional depending on the geometry of the channel under test and the turbulence of the flow, among other variables.

In an embodiment, nonlinear particle paths may be calculated via three illuminated planar cross sections with different colors. The calculation would include information taken from the recorded images, such as the position of the particle, and a timestamp of each recorded image.

The described method and system to characterize the velocity of a fluid flow improve on the currently used particle image velocimetry methods. For example, using off the shelf color digital cameras, data may be automatically recorded synchronously. No special filters are needed for the camera. Additionally, using off the shelf digital color camera options make this proposed method relatively inexpensive to implement. No specialty cameras with special timing circuits used for strobe syncing must be utilized. The only timestamp that matters is the singular timestamp generated by the one camera. Furthermore, the use of three laser sheets adds another level of accuracy resulting in the ability to have higher accuracy and/or the ability to collect more complex particle paths. Lastly, an embodiment of the proposed method utilizes the characterization of the velocity of the air flow in a gas turbine inlet to calculate the air mass flow.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A method to characterize the velocity of a fluid flow through a flow channel using particle image velocimetry, comprising:
introducing a fluid flow into the fluid channel, the fluid flow including a plurality of fluid particles and a plurality of tracer particles;
illuminating at least two planar cross sections of the fluid flow, the planar cross sections spaced apart by a distance, wherein each planar cross section, is illuminated with a light source of a different color;
recording successive images such that each illuminated planar cross section, of the fluid flow is captured separately with a single image receiver having a field of view; and
determining the velocity of a fluid flow through the flow channel using the captured images.

2. The method as claimed in claim 1,
wherein the at least two planar cross sections are illuminated by different colors, and
wherein the different colors are selected from the group consisting of red, green, and blue.

3. The method as claimed in claim 1, further comprising positioning the image receiver such that the successive images are captured having the same field of view.

4. The method as claimed in claim 3, wherein the image receiver is positioned within the flow channel downstream from the illuminated planar cross sections so that the field of view includes each illuminated planar cross section.

5. The method as claimed in claim 1, wherein adjacent illuminated planar cross sections are spaced apart by a distance in a range of 1 mm to 1 m.

6. The method as claimed in claim 1, wherein the image receiver is a digital color camera including a multichannel imager.

7. The method as claimed in claim 6, wherein the frame rate of the digital color camera is in a range of 10 FPS (frames per second) to 100,00 FPS.

8. The method as claimed in claim 1, wherein the determining is accomplished via a processor communicatively coupled to the image receiver by:
recovering an illumination of each of a plurality of tracer fluid particles from a corresponding captured image, the illumination occurring as a result of each tracer particle passing through each illuminated planar cross section, and
determining a position and timing of each tracer particle within a corresponding planar cross section utilizing the position of the illumination within the corresponding planar cross section, and
determining the velocity of each tracer particle using the position and timing of the tracer particle within the at least two planar cross sections.

9. The method as claimed in claim 8, wherein the position of each tracer particle within the planar cross section is calculated utilizing the position of the illumination within the planar cross section, the geometry of the planar cross section and the position of the image receiver, and
wherein the timing of each tracer particle within the planar cross section corresponds to a timestamp recorded for the captured image.

10. The method as claimed in claim 1, further comprising estimating the velocity of fluid flow by employing statistical methods on the velocities of the plurality of tracer particles.

11. The method as claimed in claim 10, wherein a velocity flow field is created using the estimated velocity.

12. The method as claimed in claim 1, further comprising illuminating at least three planar cross sections of the fluid flow, the planar cross sections spaced apart by a distance, wherein each planar cross section is illuminated with a light source of a different color.

13. The method as claimed in claim 12, wherein a three-dimensional representation of the velocity field of the fluid flow is created.

14. A system to characterize the velocity of a fluid flow through a flow channel using particle image velocimetry, comprising:
a flow channel through which a fluid flows, the fluid comprising a plurality of fluid particles and a plurality of tracer particles;
a plurality of light sources, each comprising a different color, supplying optical or infrared radiation in the form of a laser sheet, each laser sheet illuminating a separate cross section of fluid flow in the different color;
a single image receiver, having a field of view, for capturing images of each laser sheet; and
a processor, communicatively coupled to the single image receiver, adapted to receive and analyze the captured images of the laser sheets.

15. The system as claimed in claim 14, wherein the single image receiver is a digital color camera including a multichannel imager.

16. The system as claimed in claim 15, wherein the frame rate of the digital color camera is in a range of 10 FPS to 100,000 FPS.

17. The system as claimed in claim 13, wherein the image receiver is positioned such that the successive images are captured having the same field of view.

18. A method for measuring air mass flow into an inlet of a gas turbine engine, comprising:
introducing an air flow into an inlet of the gas turbine engine;
illuminating at least two planar cross sections of the air flow, the planar cross sections spaced apart by a distance, wherein each planar cross section is illuminated with a light source of a different color;
positioning a single image receiver downstream of the inlet, the single image receiver having a field of view of each illuminated planar cross section;
recording successive images such that each illuminated planar cross section of the fluid flow is captured separately with the single image receiver; and
determining from the captured successive images the velocity of each of a plurality of tracer particles utilizing the position of each tracer particle in each corresponding illuminated planar cross section and the timestamp of the captured images;
creating a velocity field of the air flow into the inlet using the determined velocities of the plurality of tracer particles;
creating a density field of the air flow into the inlet; and
combining the velocity field with the density field to calculate an air mass flow field.

19. The method as claimed in claim 18, further comprising:
illuminating at least three planar cross sections of the air flow, the planar cross sections spaced apart by a distance, wherein each planar cross section is illuminated with a light source of a different color,
characterizing a three-dimensional velocity field of the air flow into the inlet using the captured images,
characterizing a three-dimensional density field of the air flow into the inlet, and
combining the velocity field with the density field to calculate a three-dimensional air mass flow field.

20. The method as claimed in claim 18, further comprising characterizing nonlinear particle paths via the use of three illuminated planar cross sections with different colors, and
wherein the nonlinear particle paths are characterized using the recorded images and a timestamp of each recorded image.
